(19) United States
(12) Patent Application Publication
(10) Pub. No.: US 2018/0282552 A1
(43) Pub. Date: Oct. 4, 2018

(54) ONE-SOLUTION TYPE PHOTOCATALYST-CONTAINING COATING SUSPENSION AND METHOD OF PREPARING THE SAME

(71) Applicants: Young KIM, (US); Hyeok Jung KIM, (US)

(72) Inventors: Hyeok Jung KIM, Cheonan-si, Chungcheongnam-do (KR); Yong Kyeong HWANG, Seoul (KR)

(73) Assignees: Young KIM, Seoul (KR); Hyeok Jung KIM, Cheonan-si, Chungcheongnam-do (KR)

(21) Appl. No.: 15/524,393

(22) PCT Filed: Nov. 4, 2015
(86) PCT No.: PCT/KR2015/011732

§ 371 Date: May 4, 2017

(30) Foreign Application Priority Data
Nov. 4, 2014 (KR) 10-2014-0152261

(51) Int. Cl. C09D 5/02; B01J 21/06; B01J 35/00; B01J 37/00

(52) U.S. Cl. CPC C09D 5/022; B01J 21/063; B01J 35/0013; B01J 37/0027; B01J 35/004

(57) ABSTRACT

There is provided one-solution type photocatalyst-containing coating suspension comprising: 100 parts by weight of an aqueous solution including deionized water; 2 to 15 parts by weight of photocatalyst powders, wherein each of the photocatalyst powders receives light from an outside and exhibits a photocatalytic effect; 10 to 20 parts by weight of a negatively charged surfactant, wherein the surfactant surrounds the photocatalyst powders such that the photocatalyst powers are micellized into micelles dispersed in the aqueous solution; 5 to 15 parts by weight of colloidal inorganic binders dispersed in the aqueous solution.

### BACKGROUND OF THE DISCLOSURE

### Field of the Disclosure

The present disclosure relates to one-solution type photocatalyst-containing coating suspension and a method of manufacturing the same. More particularly, the present disclosure relates to one-solution type photocatalyst-containing coating suspension and a method for producing the same, whereby an operator may efficiently attach photocatalyst molecules to an object surface only in a single application, thereby exhibiting an excellent photocatalytic effect.

### Related Art

Generally, a photocatalyst is a material that receives light from the outside and promotes a chemical reaction. Examples of the material promoting such photochemical reaction may include semiconductor, coloring material, chlorophyll, and the like.

It has been found that the photocatalyst has a property of oxidizing and decomposing harmful substances. Thus, the photocatalyst is used to remove environmental pollution, and to exhibit antibacterial and deodorizing performance. Further, the photocatalyst has a superhydrophilic function. Thus, photocatalysts are currently being applied to a variety of products such as glass, tiles, cleaners, air purifiers, refrigerators, road pavements, curtains, wallpaper, artificial plants, concrete products, ceramic products and glass.

As photocatalysts, semiconducting metal oxides and sulfur compounds are mainly and currently used. Typical examples of the photocatalytic material may include ZnO, WO₃, SnO₂, ZrO₂, TiO₂, CdS, and CdSe.

In particular, TiO₂ photocatalyst has advantages of low cost, harmless to the human body, and semi-permanent use of light as an energy source. Therefore, products using the TiO₂ photocatalyst are attracting attention as eco-friendly and economical products.

The photocatalyst material exerts a photocatalytic effect in accordance with a well-known following reaction mechanism.

When a light energy of a predetermined wavelength is applied to the photocatalyst material, a large amount of electrons (e−) is excited from a valence band into a conduction band, and a large amount of holes (h+) is formed in a valence band. At this time, the hole (h+) reacts with water to generate a hydroxyl radical (OH−), and, oxygen in the air is reduced by the reduction reaction to generate active oxygen of superoxide anion (O₂⁻). Since these hydroxyl radicals have high oxidation and reduction potentials, it is possible to purify NOₓ, SOₓ, volatile organic compounds (VOCs) and various odorous substances.

The applications of these photocatalytic effects are very diverse. For example, as is well known, the photocatalyst is used in the outer wall of a building to remove harmful substances such as formaldehyde present in a newly constructed house, to deodorize and remove contaminants generated in offices and indoor spaces. Further, photocatalyst may oxidize and remove various organic substances and harmful gases generated in the industrial site, decompose decomposition-resistant waste water, and remove various kinds of NOₓ discharged from the vehicle. Therefore, the photocatalyst may be applied to road surface or road pavement, and be applied to a washing machine, an air purifier, a refrigerator, etc. for self-cleaning effect.

However, although the photocatalyst exhibits such an excellent effect, its practical application field is very limited. This is mainly because a technique for immobilizing the photocatalyst onto the target object in a stable state for the long-term use of the photocatalyst material has not been developed yet.

Currently, a general method for immobilizing the photocatalyst material may be broadly classified into an organic binder mixing method, an inorganic binder mixing method, a photocatalyst direct fixing method, and a two-solution type fixing method, as described below.

First, in the organic binder mixing method, the photocatalyst material is mixed with an organic binder in a predetermined amount, and the mixture is applied or thin-film on the object surface. However, in this method, since the organic binder component is decomposed by the oxidation-reduction reaction of the photocatalyst material, the weather resistance is not good.

Next, in order to improve the disadvantage of the organic binder mixing method, an inorganic binder component is mixed with the photocatalyst material instead of the organic binder. In this case, the inorganic binder component is not easily decomposed by the photocatalytic reaction, but the inorganic binder component surrounds the photocatalyst material exhibiting the photocatalytic effect. As a result, there is a disadvantage that it is difficult to substantially expect the photocatalytic effect.

On the other hand, in the above-described direct fixing method of the photocatalyst, the photocatalyst material is directly fixed to the surface of the target object without using an organic binder or an inorganic binder. In this method, since the photocatalyst material is directly fixed to the target object and no foreign material (that is, a binder component) exists near the object or on the surface of the object, there is an advantage that the photocatalytic effect can be exhibited theoretically in the best manner. However, in order to directly fix the photocatalyst material on the target object after spraying the photocatalyst material on the target object, expensive equipment must be used. Further, application range of the target object is too limited.

Furthermore, the two-solution type fixing method is a method in which the above-mentioned conventional methods are further improved. In this method, an inorganic binder component is first applied to the surface of a target object to form an inorganic binder layer, and thereafter, a photocatalyst material is sprayed on the inorganic binder layer to immobilize the photocatalyst material. In this method, the photocatalyst material is not buried by the binder component. However, since an inorganic binder layer is formed on the target object and a photocatalyst layer is formed on the inorganic binder layer again, there is a disadvantage that the work must be performed in duplicate. In addition, there is a disadvantage in that the target object must be limited to a specific application range.

As described above, although the usefulness of the photocatalyst material is recognized, an approach enabling the photocatalyst material to be used widely and being easy and simple to use has not been developed yet.

### PRIOR ART DOCUMENT

### Patent Literature

(Patent Document 1) Korean Patent No. 10-1167600 “Photocatalytic concrete production method” (Jul. 16, 2012);
(Patent Document 2) Korean Patent No. 10-1167625 “Method of manufacturing photocatalytic concrete” (Jul. 16, 2012);
(Patent Document 3) Korean Patent Application Laid-Open No. 10-2011-3893 “Photocatalytic coating composition containing titanium dioxide and coating method Using the same” (Jan. 13, 2011);
(Patent Document 4) Korean Patent No. 10-509562 “Aqueous inorganic photocatalytic paint containing super-fine powders of titanium dioxide” (Aug. 12, 2005);
(Patent Document 5) Korean Patent No. 10-453446 “Method of producing photocatalytic dispersion” (Jun. 23, 2004);
(Patent Document 6) Korean Patent No. 10-482649 “Method of directly fixing photocatalyst on substrate” (Apr. 1, 2005);
(Patent Document 7) Korean Patent No. 10-424082 “Method of producing binder composition for photocatalytic paint” (Mar. 10, 2004)
(Patent Document 8)

### SUMMARY OF THE DISCLOSURE

In order to solve all the problems of the prior arts, the present disclosure provide one-solution type photocatalyst-containing coating suspension and a method for producing the same, whereby an operator may efficiently attach photocatalyst molecules to an object surface only in a single application, thereby exhibiting an excellent photocatalytic effect.

In one aspect of the present disclosure, there is provided one-solution type photocatalyst-containing coating suspension comprising: 100 parts by weight of an aqueous solution including deionized water; 2 to 15 parts by weight of photocatalyst powders, wherein each of the photocatalyst powders receives light from an outside and exhibits a photocatalytic effect; 10 to 20 parts by weight of a negatively charged surfactant, wherein the surfactant surrounds the photocatalyst powders such that the photocatalyst powers are micellized into micelles dispersed in the aqueous solution; 5 to 15 parts by weight of colloidal inorganic binders dispersed in the aqueous solution.

In one embodiment, when the photocatalyst powders absorb light energy of a given wavelength, electrons (e−) and holes (h+) are generated in the photocatalyst powders, wherein the electrons and the holes enable a material contacting the photocatalyst powders to undergo a redox reaction, wherein the photocatalyst powders include semi-conductive metal oxides or sulfur compound.

In one embodiment, the photocatalyst powders include at least one selected from a group consisting of ZnO, WO₃, SnO₂, ZrO₂, TiO₂, CdS, and CdSe.

In one embodiment, wherein the photocatalyst powders include titanium dioxide (TiO₂).

In one embodiment, titanium dioxide (TiO₂) includes a combination of anatase and rutile forms thereof in a ratio of 2:8 to 8:2.

In one embodiment, the surfactant micellizes the photocatalyst powders so as to suppress contacts between the photocatalyst powders and the binders.

In one embodiment, the negatively charged surfactant includes at least one selected from a group consisting of sodium stearate, sodium dodecyl sulfate, sodium dodecylbenzenesulfonate, sodium laureth sulfate, sodium lauroyl sarcosinate, sodium myreth sulfate, and sodium pareth sulfate.

In one embodiment, the inorganic binders are present in the form of a colloid in the aqueous solution, wherein when a mixture of an initiator and the one-solution type photocatalyst-containing coating suspension is applied on a target object, moisture is gradually evaporated from a surface of the object, and, thus, the inorganic binder gradually exhibits an adhesive force.

In one embodiment, the inorganic binder includes a porous zeolite-based binder, or includes a silicon-based binder having Si—O bonds having a larger binding energy on a main chain thereof.

In one aspect of the present disclosure, there is provided a method for producing one-solution type photocatalyst-containing coating suspension, the method comprising: providing 100 parts by weight of an aqueous solution including deionized water; adding into the aqueous solution 2 to 15 parts by weight of photocatalyst powders and 10 to 20 parts by weight of a negatively charged surfactant, to form a first mixture wherein each of the photocatalyst powders receives light from an outside and exhibits a photocatalytic effect; stirring the first mixture such that the photocatalyst powers are micellized into micelles using the surfactant, wherein the micelles are dispersed in the aqueous solution to form a first suspension; and adding and stirring 5 to 15 parts by weight of colloidal inorganic binders into the first suspension, thereby to form the photocatalyst-containing coating suspension in which the micelles and the binders are dispersed uniformly.

In one embodiment, the method further comprises adjusting pH of the first suspension to a range of pH 7 to pH 10 for stabilization of the first suspension.

According to the present disclosure, the present suspension is advantageous in that it is present as a suspension and is present as a stable solution while containing the photocatalyst material and the inorganic binder component at the same time. Further, since the upper surface of the photocatalyst material is opened so as to be contactable with the outside without being surrounded by the binder component in a state where the photocatalyst material is fixed to the target object, the photocatalytic effect is very advantageous. In addition, since the present suspension is of a one-solution type, the operator may complete the application in only one step, which is advantageous in that the work may be carried out very simply and easily. In addition, the present suspension does not need to use a specific application means, and may be used as usual application means which may be generally used today, so that its application range is very wide. In addition, the use of the present suspension is not limited to a person having a specific skill or function, and has an advantage that general person may easily use the suspension.

### BRIEF DESCRIPTION OF THE DRAWINGS

FIG. 1 shows conceptual diagrams illustrating a reaction process of one-solution type photocatalyst-containing coating suspension according to the present disclosure.

FIG. 2 shows a conceptual diagram illustrating a reaction process of a conventional two-solution type photocatalyst-containing coating suspension.

### DETAILED DESCRIPTION

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

According to the present disclosure, a photocatalyst-containing coating suspension includes 100 parts by weight of an aqueous solution including deionized water. As the above-mentioned aqueous solution, water generally used may be used. Preferably, deionized water may be used.

According to the present disclosure, the one-solution type photocatalyst-containing coating suspension comprises 2 to 15 parts by weight of a photocatalyst material that receives light from the outside and exhibits a photocatalytic effect.

When the light energy of a certain wavelength is applied to the photocatalyst material, a large amount of electrons (e−) and a large amount of holes (h+) are generated in the material. Thus, the redox reaction is caused by the electrons and the holes in various materials existing nearby the photocatalyst material. As the photocatalyst material, semiconductive metal oxides may be exemplified. More specifically, ZnO, WO₃, SnO₂, ZrO₂, TiO₂, CdS, CdSe and the like may be exemplified. It is preferable that the photocatalyst material is processed into a fine powder. This is because when the powder is processed into a fine powder, its surface area may be widened and a reaction portion may be increased. A size of the fine powder is preferably in a range commonly used in this technical field. Such fine powders may be readily purchased and used by those skilled in the art.

Among the above photocatalyst materials, titanium dioxide (TiO₂) may be used in accordance with the preferred embodiment of the present disclosure. Titanium dioxide (TiO₂) exists in three following forms: anatase form, rutile form, and brookite form, depending on crystal arrangement. Among the forms, widely used and actually available forms are anatase form and rutile form. This is because that the rutile type has the most stable state of TiO₂, and the anatase form may be easily crystallized at low temperatures. The anatase form has good surface activity and is sensitive to the photoactive reaction. The rutile form has the advantages of good white brightness and hiding ability.

According to the present disclosure, the crystalline forms may be used singly or in combination with each other. The latter case may be advantageous because it is often more efficient to mix the forms appropriately depending on use environments thereof. According to the present disclosure, when the forms are mixed with each other, it is preferable to mix the anatase form and rutile form in a ratio of 2:8 to 8:2. The mixing ratio may be specifically determined in consideration of the properties of the anatase form and the rutile form based on a given environment.

The photocatalyst material is preferably used in an amount of 2 to 15 parts by weight based on 100 parts by weight of the aqueous solution. When the photocatalyst material is used in an amount of less than 2 parts by weight, the content thereof is too small to exert a photocatalytic effect. On the other hand, when the photocatalyst material is contained in an amount exceeding 15 parts by weight, the degree of increase of the photocatalytic effect is not proportional to the added amount thereof, and accordingly, the amount of the surfactant to be added is increased, which is not preferable.

According to the present disclosure, the one-solution type photocatalyst-containing coating suspension comprises 10 to 20 parts by weight of a negative charged surfactant which micellizes the photocatalyst material in the aqueous solution.

The negative charged surfactant is added to micellize the photocatalyst material dispersed in the aqueous solution. When the negative charged surfactant is contained in the aqueous solution in an amount exceeding 10 parts by weight based on 100 parts by weight of the aqueous solution, the surfactant surrounds the photocatalyst material dispersed in the aqueous solution, and, thus, gradually micellizes the photocatalyst material. Therefore, when the negative charged surfactant is contained in an amount of less than 10 parts by weight based on the weight of the aqueous solution, micelle formation is difficult. On the other hand, when the negative charged surfactant is contained in an aqueous solution in an amount of more than 20 parts by weight based on 100 parts by weight of the aqueous solution, an excessive amount of the surfactant may suppress the colloid formation, which is undesirable.

The negative charged surfactant may be used without limitation as long as it encapsulates the photocatalyst material and micellizes it. According to the present disclosure, by micellizing the photocatalyst material, the photocatalyst material is not bonded to an inorganic binder component to be added later in the aqueous solution. In other words, micelles resulting from the micellization of the photocatalyst material using the negative charge surfactant may serve as a blocking layer which basically prevents the photocatalyst material from reacting with the external inorganic binder component.

As the negative charged surfactant, typically, sodium stearate and sodium dodecyl sulfate are most preferred. In addition, surfactants such as sodium dodecylbenzenesulfonate, sodium laureth sulfate, sodium lauroyl sarcosinate, sodium myreth sulfate, and sodium pareth sulfate may be used.

According to the present disclosure, the one-solution type photocatalyst-containing coating suspension comprises 5 to 15 parts by weight of a colloidal inorganic binder dispersed in the aqueous solution.

The colloidal inorganic binder refers to a binder component of the inorganic material existing in a colloidal state inside the aqueous solution. The inorganic binder is present in the form of a colloid in the aqueous solution. However, when an initiator such as water is added to the one-solution type photocatalyst-containing coating suspension, and the composition is applied to the surface of the target object, moisture is gradually evaporated from the surface of the object, and, thus, the inorganic binder gradually exhibits an adhesive force.

The colloidal inorganic binder may be a zeolite-based binder which is not easily decomposed by the photocatalytic effect unlike the organic binder.

The inorganic binder may include a porous zeolite-based binder, or may include a silicon-based binder having Si—O bonds having a large binding energy between elements on the main chain. Since the inorganic binder must be dispersed in a stable state in the aqueous solution, the inorganic binder is preferably formed in a colloidal form.

When the colloidal inorganic binder is contained in an amount of less than 5 parts by weight based on 100 parts by weight of the aqueous solution, the inorganic binder content is not preferable because of the weak adhesive force of the binder when the present coating suspension is applied to the object to be coated. On the contrary, when the inorganic binder is contained in an amount exceeding 15 parts by weight, the stability of the aqueous solution may be deteriorated due to the excessive content of the binder, which is not preferable. As the colloidal inorganic binder, for example, colloidal-phase porous silica or aluminosilicate is most preferable.

Furthermore, in accordance with the present disclosure, there is provided a method for producing the one-solution type photocatalyst-containing coating suspension as described above.

A method for manufacturing the one-solution type photocatalyst-containing coating suspension according to the present disclosure includes a first step for adding 2 to 15 parts by weight of a photocatalyst material which receives light from the outside and exhibits a photocatalytic effect and 10 to 20 parts by weight of a negative charged surfactant into 100 parts by weight of the aqueous solution including deionized water, and then dispersing the photocatalyst material and the surfactant in the aqueous solution uniformly to form a suspension.

According to the present disclosure, 2 to 15 parts by weight of the photocatalyst material is added to 100 parts by weight of the aqueous solution of deionized water and is dispersed uniformly in the solution. The photocatalyst material may be finely pulverized and may be weighed and commercially purchased from the market. In order to uniformly disperse the photocatalyst material in the solution, a mixing process may be performed uniformly, and ultrasound treatment may be supplementarily performed, if necessary.

According to the present disclosure, 10 to 20 parts by weight of the negatively charged surfactant is added to 100 parts by weight of the above aqueous solution in which the photocatalyst component is uniformly dispersed, thereby to form a first mixture. Then, the first mixture is uniformly stirred to obtain a uniformly dispersed suspension. At this time, the suspension contains a plurality of micelles dispersed in a colloidal form therein, each micelle being formed of the photocatalyst component surrounded by the surfactant.

According to the present disclosure, after the suspension having the micelles of the photocatalytic material and the negatively charged surfactant dispersed therein is slowly stirred, the pH of the suspension is adjusted to a range of 7 to 10 for the stabilization of the suspension. This pH adjustment may be achieved using sodium hydroxide (NaOH).

According to the present disclosure, the method for manufacturing the one-solution type photocatalyst-containing coating suspension according to the present disclosure includes a second step for adding 5 to 15 parts by weight of the colloidal inorganic binder component to the water-soluble suspension containing the colloidal micelles and the negatively charged surfactant therein to form a second mixture, and uniformly dispersing the binder, the micelles and the surfactant in the second mixture.

According to the present disclosure, 5 to 15 parts by weight of the above-mentioned colloidal inorganic binder component based on 100 parts by weight of the aqueous solution is added to the aqueous suspension to prepare the suspension, and the suspension is uniformly stirred such that the binder, the micelles and the surfactant are uniformly dispersed in the suspension.

When the colloidal inorganic binder component is introduced into the aqueous suspension, the inorganic binder component is dispersed in the suspension as it is in non-contact with the photocatalyst powder. This is because the photocatalyst powder is already micellized and cannot physically contact the inorganic binder.

Hereinafter, a preferred example of the present disclosure will be described.

### Example

A 2-liter vessel was prepared. Then, in the vessel, 100 g of titanium dioxide (TiO₂) was introduced into 1000 g of deionized water to form a first mixture. Then, the first mixture was stirred slowly. Then, 150 g of sodium dodecyl sulfate was added to the first mixture to form a second mixture, which was continuously stirred for 1 hour.

With continued stirring of the second mixture, 120 g of colloidal silica was added to the second mixture in the vessel to form a third mixture which was then stirred for a further 30 minutes. Thus, a reaction solution was obtained as a final suspension.

The thus-prepared one-solution type photocatalyst-containing coating suspension maintains a stable state of the suspension. Therefore, after the water as the initiator is mixed with the suspension solution to form a mixture, the mixture is applied to the surface of the target object, or sprayed or thin-filmed. As the water evaporates from the photocatalyst-containing coating suspension applied on the surface of the object, the inorganic binder component in the colloidal state gradually comes into contact with the surface of the object and exhibits the adhesion. At this time, when the worker pours water on the surface of the object and rinses it, the micelle structure is destroyed, and the surfactant existing around the micelle is dissolved in water and, thus, washed away from the object together with water.

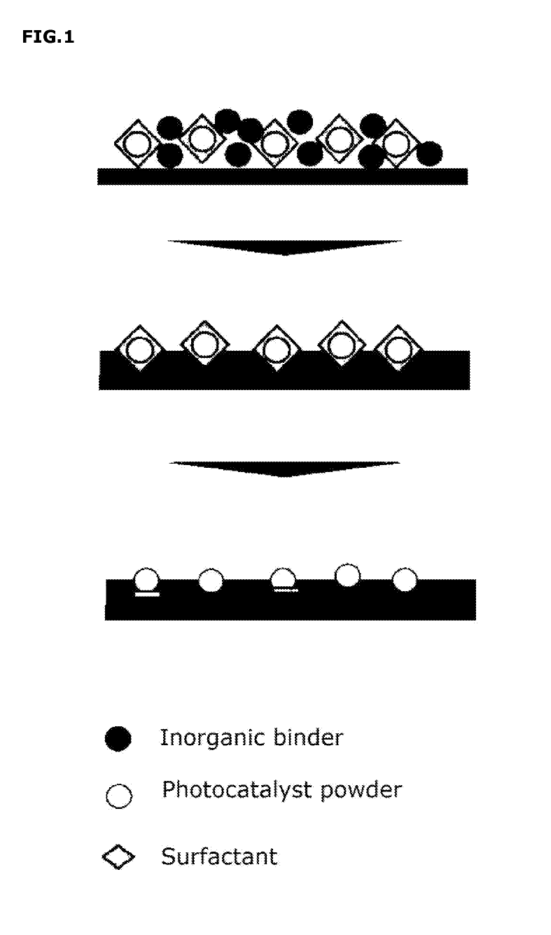

FIG. 1 is a visual conceptual view showing a relationship between the photocatalyst material and the inorganic binder after the one-solution type photocatalyst-containing coating suspension according to the present disclosure is applied to a surface of a target object.

Therefore, the photocatalyst material is fixed to the surface of the object by the inorganic binder component on a bottom side of the photocatalyst material. However, on a top side of the photocatalyst material, the surface active agent or surfactant is dissolved in the water and is washed away from the object together with water. Thus, on the top side of the photocatalyst material, open sections may formed. Through the open section, the photocatalyst material may freely contact outside air or room air.

On the contrary, when using a conventional two-solution type photocatalyst-containing coating suspension, the photocatalyst material is surrounded by the inorganic binder component on the surface of the target object. Therefore, reduction in the photocatalytic effect may be worsened as much as the photocatalyst material is surrounded by the inorganic binder component.

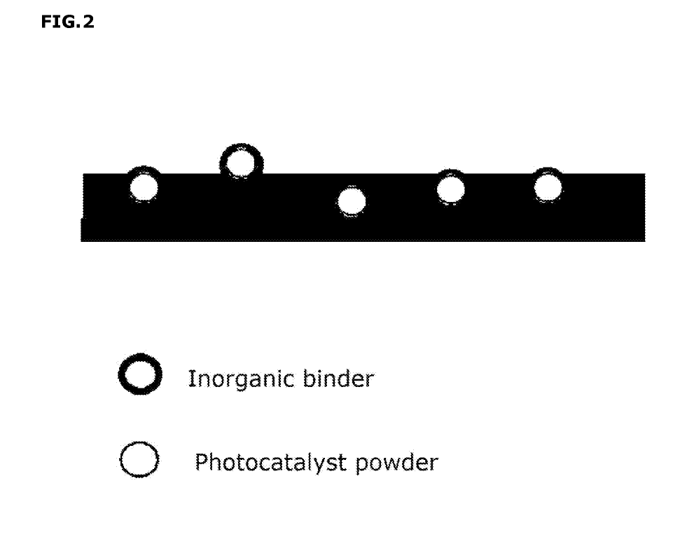

FIG. 2 is a conceptual view showing a relationship between a photocatalyst material and an inorganic binder component when using a conventional two-solution type photocatalyst-containing coating suspension.

The one-solution type photocatalyst-containing coating suspension according to the present disclosure and its preparation method have been above described in detail. However, the present disclosure is not limited thereto. The scope of the present disclosure may be defined by following claims and their equivalents.

It will be apparent to those skilled in the art that various changes and modifications may be made by those skilled in the art without departing from the spirit and scope of the disclosure as defined by the appended claims.

1. One-solution type photocatalyst-containing coating suspension comprising:
100 parts by weight of an aqueous solution including deionized water;
2 to 15 parts by weight of photocatalyst powders, wherein each of the photocatalyst powders receives light from an outside and exhibits a photocatalytic effect;
10 to 20 parts by weight of a negatively charged surfactant, wherein the surfactant surrounds the photocatalyst powders such that the photocatalyst powers are micellized into micelles dispersed in the aqueous solution;
5 to 15 parts by weight of colloidal inorganic binders dispersed in the aqueous solution.

2. The suspension of claim 1, wherein when the photocatalyst powders absorb light energy of a given wavelength, electrons (e−) and holes (h+) are generated in the photocatalyst powders, wherein the electrons and the holes enable a material contacting the photocatalyst powders to undergo a redox reaction, wherein the photocatalyst powders include semi-conductive metal oxides or sulfur compound.

3. The suspension of claim 2, wherein the photocatalyst powders include at least one selected from a group consisting of ZnO, WO3, SnO2, ZrO2, TiO2, CdS, and CdSe.

4. The suspension of claim 3, wherein the photocatalyst powders include titanium dioxide (TiO2).

5. The suspension of claim 4, wherein titanium dioxide (TiO2) includes a combination of anatase and rutile forms thereof in a ratio of 2:8 to 8:2.

6. The suspension of claim 3, wherein the surfactant micellizes the photocatalyst powders so as to suppress contacts between the photocatalyst powders and the binders.

7. The suspension of claim 3, wherein the negatively charged surfactant includes at least one selected from a group consisting of sodium stearate, sodium dodecyl sulfate, sodium dodecylbenzenesulfonate, sodium laureth sulfate, sodium lauroyl sarcosinate, sodium myreth sulfate, and sodium pareth sulfate.

8. The suspension of claim 1, wherein the inorganic binders are present in the form of a colloid in the aqueous solution, wherein when a mixture of an initiator and the one-solution type photocatalyst-containing coating suspension is applied on a target object, moisture is gradually evaporated from a surface of the object, and, thus, the inorganic binder gradually exhibits an adhesive force.

9. The suspension of claim 1, wherein the inorganic binder includes a porous zeolite-based binder, or includes a silicon-based binder having Si—O bonds having a larger binding energy on a main chain thereof.

10. A method for producing one-solution type photocatalyst-containing coating suspension, the method comprising:
providing 100 parts by weight of an aqueous solution including deionized water;
adding into the aqueous solution 2 to 15 parts by weight of photocatalyst powders and 10 to 20 parts by weight of a negatively charged surfactant, to form a first mixture wherein each of the photocatalyst powders receives light from an outside and exhibits a photocatalytic effect;
stirring the first mixture such that the photocatalyst powers are micellized into micelles using the surfactant, wherein the micelles are dispersed in the aqueous solution to form a first suspension; and
adding and stirring 5 to 15 parts by weight of colloidal inorganic binders into the first suspension, thereby to form the photocatalyst-containing coating suspension in which the micelles and the binders are dispersed uniformly.

11. The method of claim 10, further comprising adjusting pH of the first suspension to a range of pH 7 to pH 10 for stabilization of the first suspension.
